(19) United States
(12) Patent Application Publication
(10) Pub. No.: US 2010/0196131 A1
(43) Pub. Date: Aug. 5, 2010

(54) RAM OPERATED VEHICLE LIFT

(75) Inventor: Pierre BLOM, NIEUW VENNEP (NL)

Correspondence Address: YOUNG & THOMPSON, 209 Madison Street, Suite 500, Alexandria, VA, 22314, US

(73) Assignee: Eric KLINKENBERG, ELSLOO (NL)

(21) Appl. No.: 12/362,682

(22) Filed: Jan. 30, 2009

(51) Int. Cl. B60P 3/07; F16H 27/02

(52) U.S. Cl. 414/471; 74/89.2

(57) ABSTRACT

Powered lift for lifting and carrying a motor cycle or other recreational vehicle behind a motor home. The lift has a base structure to be connected to the chassis of the motor home and a platform on which the motor cycle or other vehicle can be placed. Connection is through to swivel arms. In the base structure a mechanism is provided for rotatably driving the swivel arms between a lower position wherein a vehicle can be loaded/unloaded from the platform to an upper conveying position. Rotation of the swivel arms can for example be effected through a ram which displaces a chain engaging sprockets connected to the swivel arms.

### BACKGROUND OF THE INVENTION

1. Field of the Invention

The present invention relates to a powered lift to be mounted at the rear side of a motor home having a platform which can be displaced between a lower loading/unloading position and a higher conveying position.

2. Description of the Prior Art

The use of powered lifts to be mounted against the rear side of a motor home is generally known to increase the transporting capacity of such vehicle and allowing motor cycles or other vehicles or articles to be transported together with the motor home. If relatively heavy items have to be conveyed, such as motor cycles, in the prior art all kinds of lifts are used to displace the platform on which the related article has to be positioned between a lower loading position and a higher transporting position.

U.S. Pat. No. 6,884,018 discloses a system having a base structure to be connected to a conventional receiver hitch of a motor vehicle. A displaceable platform is provided and the connection between the platform and the base structure is through swivel arms. A winch is present on the base structure and the cable thereof is connected to the platform. Through operation of the winch, which can be a ram, the platform is displaced from a lower position to a higher position.

The use of an exposed cable makes the structure vulnerable and introduces a safety problem. First of all measures have to be taken that the lifting cable cannot hurt people operating the mechanism and secondly it is quite probably that eventually the exposed end of the cable will fail during a lifting operation with all negative consequences thereof.

Furthermore the lifting height of the platform is restricted to the height of the position of the winch or winch roller which means in this case the height of the base structure. This height is relatively low or requires the use of additional structures extending above the base structure of the vehicle which could however interfere functioning of doors or other ledges.

### SUMMARY OF THE INVENTION

The invention aims to provide an improved powered lift for lifting and carrying a vehicle at the rear end of a motor home.

According to a first aspect of the invention increased displacement of the platform can be obtained in that the swivel arms are displaceable between a substantially vertical position in downward direction and a substantially vertical position in upward direction. This doubles the distance over which the platform can be raised relative to the road or other surface on which it is placed during loading/unloading. Because of that additional safety is obtained preventing the platform from touching the road when negotiating bumps if the platform is in the transport position. On the other hand it is possible to realize the swivel arms with a shorter distance between the opposite swivels of each arm thus lowering the forces which act on such arms.

The rotational movement impaired to the swivel arms can for example be realized by having a sprocket connected to one or both swivel arms on which a chain or (toothed) belt engages. Displacement of the belt is effected through a ram. However, a rotational electric motor with a suitable gear can also be used to effect rotation of the swivel arms.

According to an other aspect of the invention the swivel arms are driven into rotation through a drive mechanism being in the base structure. Because of that a further lifting mechanism such as a cable is not longer necessary. There are no exposed items for rotation of the swivel arms which improves the quality of operation of the device and extends surface life.

According to a further aspect of the invention a motor home is provided and the connection of the base structure to the chassis is at a lower point than the platform in its upper conveying position.

Further advantages and objects of the invention will become clear after the following description of the accompanying drawings.

### BRIEF DESCRIPTION OF THE DRAWINGS

FIG. 1 shows a rear view of a motor home having a lift according to the invention in its transport position;

FIG. 2 shows the powered lift according to FIG. 1 in the loading/unloading position;

FIG. 3 shows a side perspective view of the powered lift according to the invention;

FIG. 4 shows details of the base structure and the swivel arm drive;

FIG. 5 shows an alternative for the embodiment of FIG. 4.

### DETAILED DESCRIPTION OF THE DRAWINGS

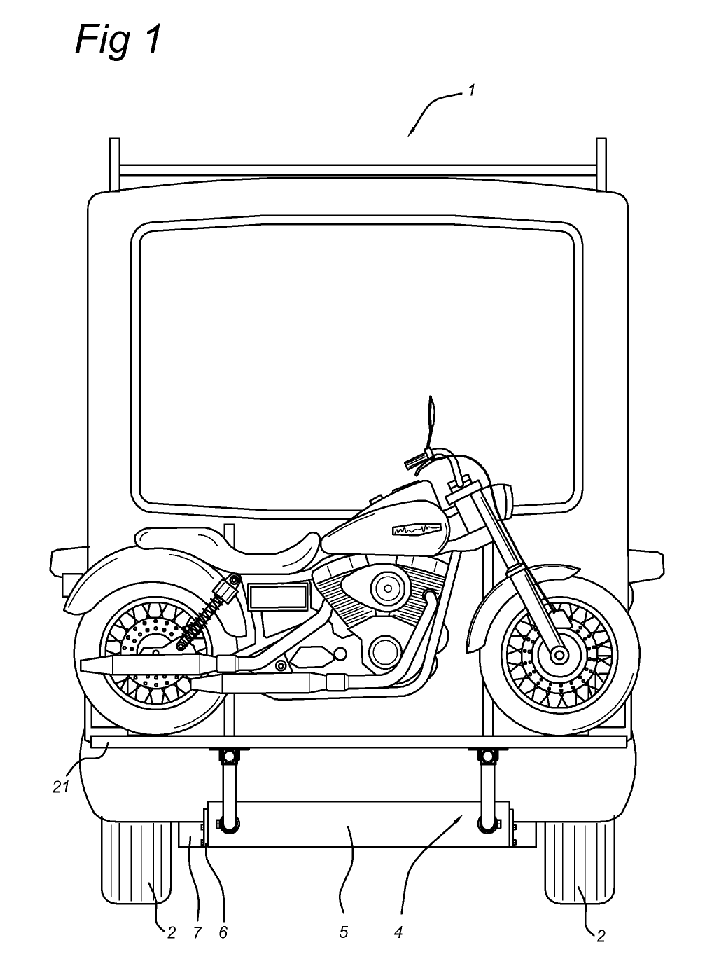

In FIG. 1 the rear side of a motor home 1 is shown. This motor home can be any vehicle being able to carry a motor vehicle or other item at the rear end thereof. The corner has reference 4.

The wheels of the motor home are indicated with 2.

For carrying a relatively heavy item such as a motor cycle it is necessary that the platform 21 of the carrier 4 can be displaced between a loading/unloading position and a higher transport position. To that end a powered lift is proposed as shown in the drawing. The powered lift comprises a base structure 5 which is connected to the chassis 7 of the motor home 1 via an attachment 6. In this embodiment attachment 6 comprises simple plates extending in length (drive) direction of the chassis and providing sufficient strength to take up the load of the carrier together with the article positioned thereon. These plates 6 are directly connected to chassis rails 7.

In the base structure two spaced arms 17 are rotatably received. The axis of rotation thereof is substantially horizontal and preferably corresponds with the length direction (drive direction) of the vehicle. At the other ends each arm is pivotally connected with platform 21. Each pivot extends in the same direction as the previous pivot. Pivoting in the base structure is through bearings 19 whilst pivoting in platform 21 is through bearings 20.

As is shown in FIG. 4 the base structure 5 comprises a U-profile in which two tubes 8 are rotatably arranged for example around pins (not shown) welded or otherwise connected to the profile and providing a bearing face for the inner side of the tubes 8. Each tube 8 is provided with a sprocket 9 being connected thereto. A chain 10 together with a chain tensioner 11 are present. The chain 10 is arranged around each sprocket and connected to a follower 15. This follower 15 is connected to piston 14 of ram 12 having a pressure connection of hydraulic feed 16.

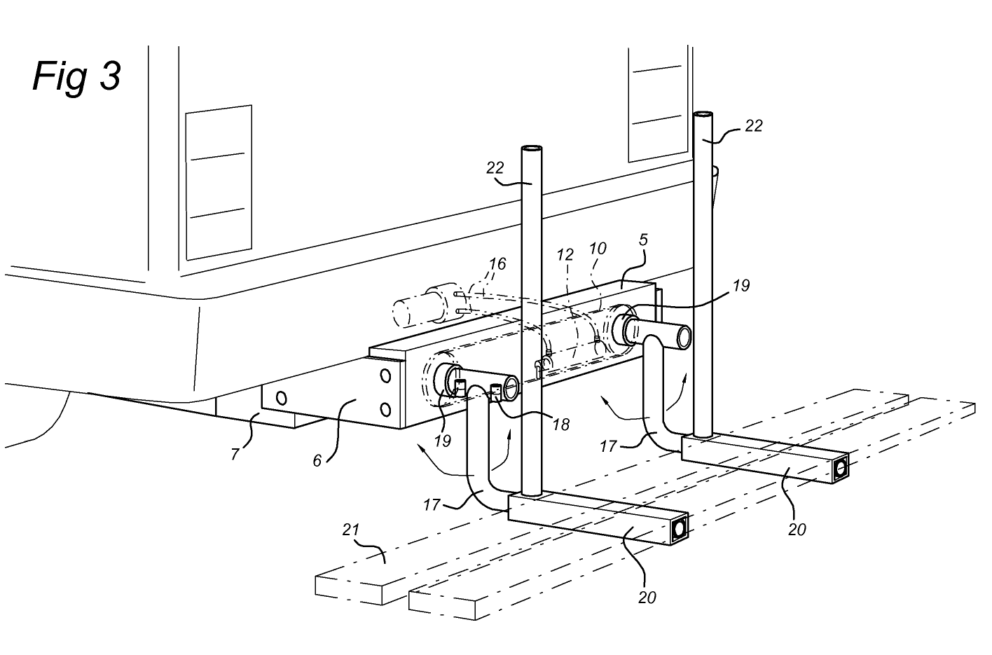

As is clear from FIG. 3 each arm 17 is connected to a related tube 8 through clamping mechanism 18. In this example the “vertical” length of arm 17 is fixed but an adjusting mechanism might be present to set the effective vertical length of arm 17. Connected to platform 21 is a support rack 22 to which the related item can be connected and preventing damages to the rear end of motor home 1.

The device described above functions as follows:

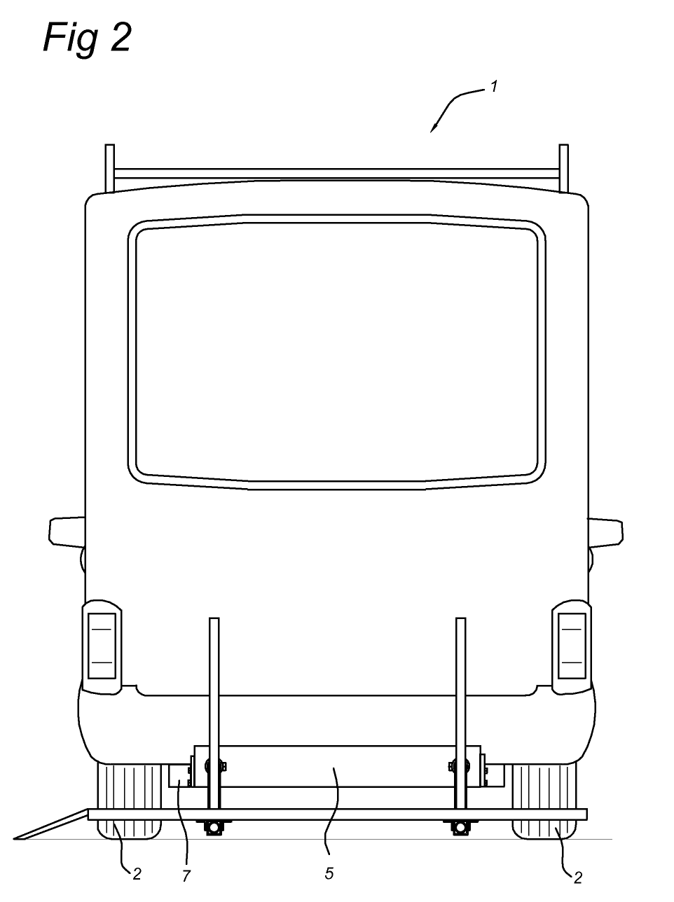

Through operation of ram 12 (with a remote control or other means for operating the valve or pump 16 providing hydraulic pressure to ram 12) piston 14 will leave ram 12 displacing the lower end of chain 10 in FIG. 4 to the right hand side and resulting in a counter clockwise rotation of each of the arms 17. Starting from the position shown in FIG. 2 wherein the platform 9 is in its lower position and arms 17 are substantially vertically downward extending through rotation of the tubes 8 because of the drive at sprockets 9 arms 17 will perform a circular counter clockwise movement (as seen in FIG. 2) lifting platform 21 from the lower position to a higher position. Because the drive for platform 21 is realized through arms 17 displacement of the platform can be beyond the position in which the arms 17 are substantially at the same level as base structure 5. This allows for further lifting of the arms 17 from the position shown in FIG. 2 through a horizontal position to the position in FIG. 1. Because of that the lower side of the platform can be fully clear of the horizontal extension of the chassis members 7 which means that a larger ground clearance is obtained for the motor home. In other words, the presence of the carrier including the lift does not impair the driving properties of the motor home with regard to bumps and other irregularities to be taken.

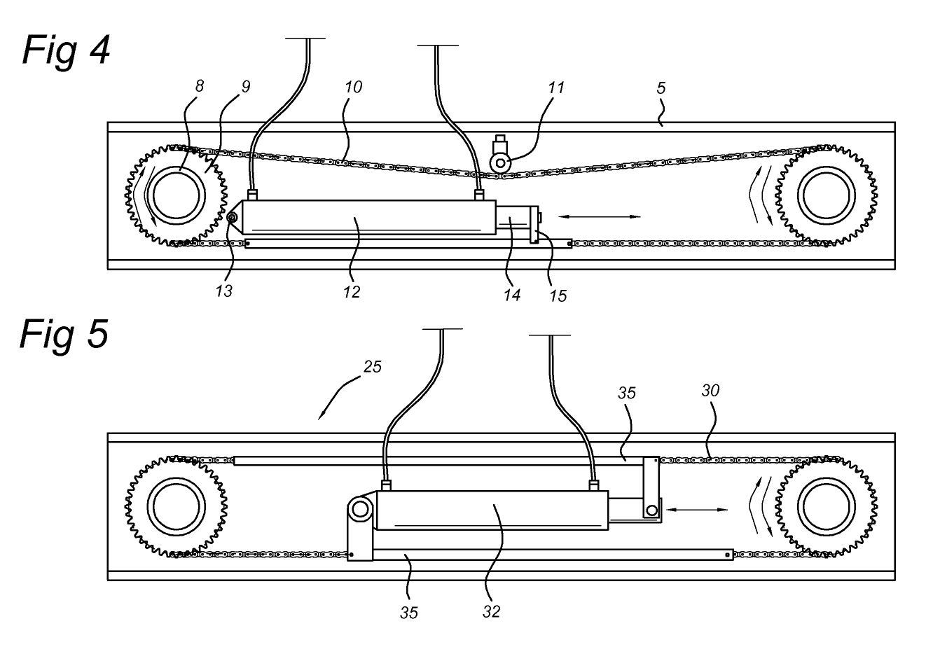

FIG. 5 shows an alternative embodiment of the base structure indicated with 25. Ram 32 is connected to both ends to a follower 35 connected to chain 30. This allows for smaller dimensioning of ram 32 but necessitates a feed for ram 32 which is also displaceable.

After the above further embodiments or changes of embodiments shown in the drawings and described above will immediately become clear for the person skilled in the art and are obvious in view of the above and within the range of the appended claims.

1. Powered lift for lifting and carrying a vehicle such as a motor cycle or recreational vehicle behind a motor home, the lift comprising a base structure having mounting means for connection to a motor home and a platform carrying said vehicle, said platform being connected to said base structure through a pair of swivel arms, each swivel arm being pivotably connected with one extremity to said base structure and being pivotably connected with the other extremity thereof to said platform, wherein in the position of use the pivot axes are substantially horizontal in order to effect a vertical movement of said platform at pivoting of said swivel arm, wherein power means are provided in said base structure to realize said vertical displacement of said platform relative to said base structure, wherein said lift is embodied such that said swivel arms can be displaced between a substantially vertically downward position and a substantially vertically upward position.

2. Powered lift according to claim 1, wherein said power means rotatably engages said two swivel arms.

3. Powered lift according to claim 1, wherein said power means comprise a linear actuator connected to a flexible transmission member and wherein said swivel arm is provided with a disk-shaped member engaging said flexible transmission member.

4. Powered lift according to claim 3 wherein said flexible transmission member comprises a chain.

5. Powered lift according to claim 1, wherein the vertical distance between the opposite pivots of a swivel arm is adjustable by adjusting the length of said swivel arm.

6. Powered lift for lifting and carrying a vehicle such as a motor cycle or recreational vehicle behind a motor home, the lift comprising a base structure having mounting means for connection to a motor home and a platform carrying said vehicle, said platform being connected to said base structure through a pair of swivel arms, each swivel arm being pivotably connected with one extremity to said base structure and being pivotably connected with the other extremity thereof to said platform, wherein in the position of use the pivot axes are substantially horizontal in order to effect a vertical movement of said platform at pivoting of said swivel arm, wherein power means are provided in said base structure to realize said vertical displacement of said platform relative to said base structure, said power means on the one hand engaging on said base structure and on the other hand rotatably engaging a swivel arm.

7. Powered lift according to claim 6, wherein said power means rotatably engages said two swivel arms.

8. Powered lift according to claim 6, wherein said power means comprise a linear actuator connected to a flexible transmission member and wherein said swivel arm is provided with a disk-shaped member engaging said flexible transmission member.

9. Powered lift according to claim 6, wherein the vertical distance between the opposite pivots of a swivel arm is adjustable by adjusting the length of said swivel arm.

10. Motor home comprising a chassis having chassis profiles at the rear end thereof to which a powered lift is connected, said powered lift comprising a base structure having mounting means for connection to a motor home and a platform carrying said vehicle, said platform being connected to said base structure through a pair of swivel arms, each swivel arm being pivotably connected with one extremity to said base structure and being pivotably connected with the other extremity thereof to said platform, wherein in the position of use the pivot axes are substantially horizontal in order to effect a vertical movement of said platform at pivoting of said swivel arm, wherein power means are provided in said base structure to realize said vertical displacement of said platform relative to said base structure, wherein said powered lift is embodied such that in the highest position of said platform relative to said base structure the lower side of said platform is above the horizontal extension of said chassis profiles.
